(19) United States
(12) Patent Application Publication
(10) Pub. No.: US 2006/0258406 A1
(43) Pub. Date: Nov. 16, 2006

(54) Portable communication terminal

(75) Inventors: Junichi Igarashi, Tokyo (JP); Toshiya Tamura, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/262,535

(22) Filed: Oct. 28, 2005

(30) Foreign Application Priority Data
May 11, 2005 (JP) 2005-138916

(51) Int. Cl. H04B 1/38

(52) U.S. Cl. 455/567

(57) ABSTRACT

In a portable communication terminal, an interrupting incoming call will be easily noticed even while the user is listening to music with a BT-connected device. When an incoming call interrupts the transmission of tune information to a BT-AV device, the transmission of tune information is stopped and then ringtone information different from the tune data that have been transmitted is transmitted to the BT-AV device, and the usual ringtone data is played thereafter.

### CROSS-REFERENCE TO RELATED APPLICATIONS

This application is based upon and claims the benefit of priory from the prior Japanese Paten Application No. 2005-138916 filed May 11, 2005; the entire contents of which are incorporated herein by reference.

### BACKGROUND OF THE INVENTION

1. Field of the Invention

The present invention relates to a portable communication terminal, and more particularly to a portable communication terminals equipped with Bluetooth™.

2. Description of the Related Art

Remarkable progress has been achieved in the field of portable information devices, and this progress has been spreading into society in recent years. In particular, cellular phones provided with a variety of functions started appearing on the market, and cellular phones equipped with Bluetooth (registered trademark, abbreviated as “BT”) are no exception.

For BT communication systems, Japanese Patent Application Laid-open No. 2002-261686, for example, suggested a wireless communication method for a BT communication system in which an electronic device (for example, a cellular phone) equipped with BT searches BT devices located in its neighborhood and takes an electronic device (for example, a headphone) selected from a plurality of discovered devices as an object to which the communication is to be connected.

In the following description, in a procedure for establishing BT communication, an apparatus which issues a processing request necessary for establishing the connection for communication or the operation of such an apparatus will be referred to as “client”, and an apparatus which receives the request of the client and outputs processing results necessary for establishing the connection for the communication or the operation of such an apparatus will be referred to as “server”.

For example, in an electronic device carrying BT and a n electronic device which is connectable to the electronic device carrying BT (referred to as “BT-AV device”), the connection by BT (referred to as “BT-AV connection”) has to be established, and a musical tone recorded in the electronic device carrying BT has to be transmitted as tone information for sound output in the BT-AV device. However, in the case where an incoming call arrives to the electronic device carrying BT while the sound is being outputted in the BT-AV device, it is necessary that the user becomes ware of this incoming call by some method.

### SUMMARY OF THE INVENTION

The present invention has been made in view of the above circumstances and provides a portable communication terminal that makes it possible for a user to come to notice easily about interrupting incoming call even when the user are listening to music with the BT-connected device.

According to an aspect of the present invention, a portable communication terminal comprises a memory configured to store a plurality of music data and ringtone data; a sound ringing unit configured to ring a prescribed ringtone based on the ringtone data stored in the memory; a close-range wireless communication unit configured to transmit a desired first music data from among the plurality of music data stored in the memory to an external device having an external close-range wireless communication function; and a controlling unit configured to stop the transmission of the first music data and transmit a second music data different from the first music data stored in the memory to the wireless device to the external device if an incoming call interrupts the transmission of the first music data, and then ring a prescribed ringtone based on the ringtone data with the sound ringing unit.

### BRIEF DESCRIPTION OF THE DRAWINGS

In the accompanying drawings:

FIGS. 1A and 1B show an external appearance of the cellular phone 1 according to an embodiment of the present invention when the cellular phone 1 is opened to about 180 degrees;

FIGS. 2A and 2B show an external appearance of the cellular phone 1 of the embodiment when the cellular phone 1 is closed;

FIGS. 3A through 3C show an example of display on the display 5, an example of arrangement of keys 6, and an example of arrangement of operation zones of the electrostatic touch pad 14 in the embodiment;

FIG. 4 is a block diagram illustrating in a simple manner the configuration of the cellular phone 1 of the embodiment;

FIG. 5 illustrates the connection relationship of the cellular phone 1 and BT headphone 200 or BT component and the external appearance of the BT headphone 200 in the embodiment;

FIG. 6 is a block diagram illustrating in a simple manner the configuration of the BT headphone 200 of the embodiment;

FIG. 7 is a flowchart relating to the case where an incoming call interrupts the tune reproduction in the cellular phone 1 of the embodiment;

FIG. 8 is a flowchart illustrating the MP start operation of the embodiment;

FIG. 9 is a flowchart illustrating the BT-AV connection start operation in the embodiment;

FIG. 10 is a flowchart illustrating the MP operation and speaker/earphone output operation in the embodiment;

FIG. 11 is a flowchart illustrating the MP operation and BT-AV connection device output in the embodiment; and

FIGS. 12A through 12C are explanatory drawings illustrating the file format in which the music reproduction unit 105 of the cellular phone 1 of the embodiment conducts transmission to an external BT device

### DETAILED DESCRIPTION OF THE INVENTION

Embodiment relating to the case where the present invention is employed in a cellular phone will be explained hereinbelow with reference to the accompanying drawings.

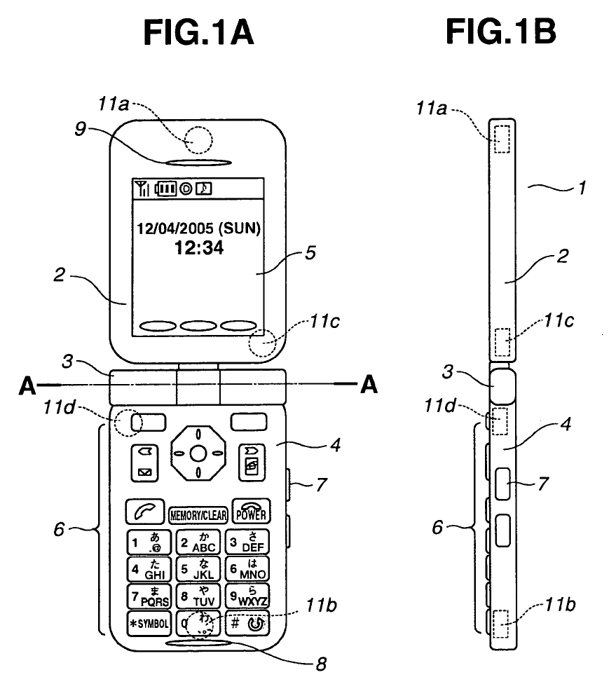

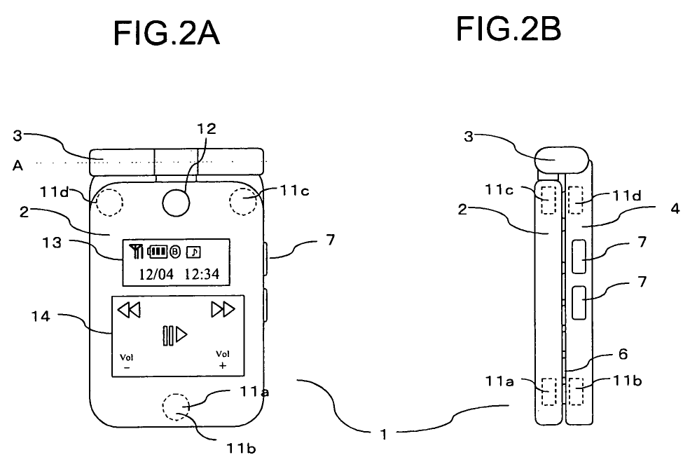

First, the structure of the cellular phone 1 will be explained referring to FIG. 1 and FIG. 2. FIG. 1 shows an external appearance of the cellular phone 1 opened to about 180 degrees in which FIG. 1A is a front view thereof, and FIG. 1B is a side view thereof. FIG. 2 shows the cellular phone 1 in closed state in which FIG. 2A is a front view thereof, and FIG. 2B is a side view thereof

The cellular phone 1 comprises an upper case section 2 and a lower case section 4 which are connected to the upper section 2 via a hinge 3. The upper case section 2 comprises a display 5 such as an LCD, a receiver 9 for playing a sound of received voice, magnetic sensors 11a, 11c for detecting the state of the cellular phone 1, a camera 12, a sub-display 13 such as an LCD, and an electrostatic touch pad 14. The display 5, camera 12, and electrostatic touch pad 14 are provided on the same surface of the upper case section 2.

The lower case section 4 comprises digit/letter keys 6 for inputting, e.g., digits, letters or operations of the cellular phone 1, side keys 7 for conducting operations of the cellular phone 1, a microphone (mouthpiece) 8 for sound collection, and magnetic sensors 11b, 11d for detecting the state of the cellular phone 1.

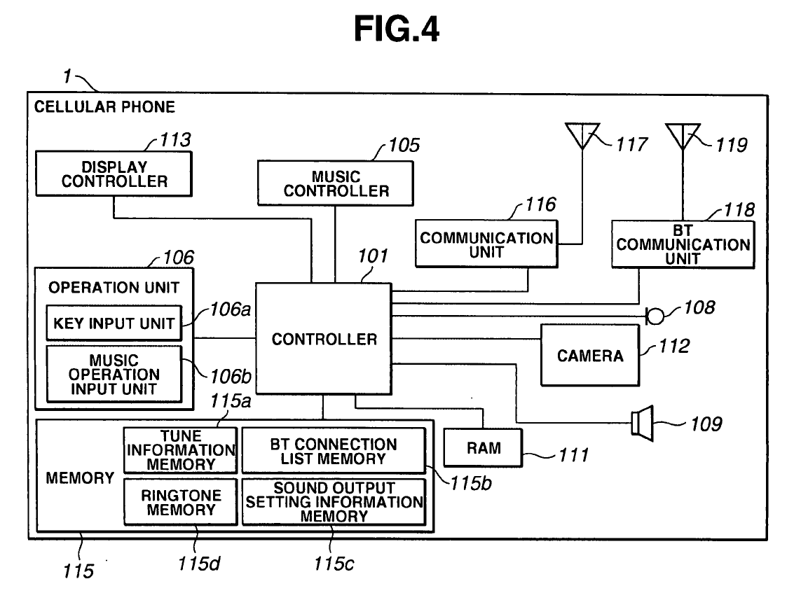

FIG. 4 is a block diagram illustrating the configuration of the cellular phone 1.

The cellular phone 1 comprises inside thereof a controller 101 for conducting control of the entire cellular phone 1, a microphone controller 108, a speaker 109, a camera controller 112 for controlling the camera 12, a nonvolatile memory 115 comprising a ROM or a NAND memory, a volatile RAM 111 for temporary memory, a display controller 113 for display controlling the display 5 and sub-display 13, an operation unit 106 for recognizing that the keys 6, side keys 7, and electrostatic touch pad 14 have been pushed down, a communication unit 116 for conducting wireless communication control by using an antenna 117, a BT communication unit 118 for conducting wireless communication control by using a BT antenna 119, and a music controller 105 for conducting, e.g., music reproduction by using music information stored in the memory 115. The entire system is controlled by the controller 101.

The memory 115 stores a program executed by the controller 101 and various information data, and comprises a tune information memory 115a which stores musical tune information, a BT connection list memory 115b which stores a list for which the BT connection is possible, a sound output setting information memory 115c for storing settings of output destination for conducting sound output during tune reproduction, and a ringtone information memory 115d which stores the ringtone information notifying the BT device that there was an incoming call.

The display controller 113 controls the display 5 and sub-display 13 and display controls the display data that are instructed by the controller 101 to be outputted.

The communication unit 116 has functions of sending the information instructed by the controller 101 by wireless communication or receiving the information sent by wireless communication from a server. Furthermore, when the musical tune used for music reproduction function implemented by the music controller 105 is downloaded from the server, this is also is carried out via the communication unit 116 and antenna 117.

If the music controller 105 receives from the controller 101 an instruction to reproduce the musical tune information stored in the tune information memory 115a of the memory 115, it reads out the musical tune information stored in the tune information memory 115a and conducts reproduction control. Furthermore, when reproduction is carried out with the speaker 109 of the cellular phone 1 and an earphone (not shown in the figures) directly connected to the cellular phone 1, it is decoded with the music controller 105 and controlled so as to be outputted with the speaker 109. Furthermore, when music is reproduced in a BT-AV device different from the cellular phone 1 via the BT communication unit 118, the music controller 105 reads out the musical tune information stored in the tune information memory 105a, conducts control converting it into a separate file system corresponding to a decoder of the external BT-AV device, and conducts control to communicate with the external BT-AV device via the BT communication unit 118.

The BT communication unit 118 controls the conversion of the sent data into data corresponding to the BT connection system and the operations of transmitting and receiving data via the BT antenna 119 with the BT connection system. Furthermore, the operations of searching the peripheral BT-communicable communication terminals and establishing links prior to data transmission and reception are also controlled in a well-known manner by the BT communication unit 118.

The camera controller 112 is activated by the controller 101, and images inputted from the camera 12 are displayed, e.g., on display 5 via the display controller 113.

The operation unit 106 has a key input unit 106a for recognizing that the keys 6 and side keys 7 have been pushed and a music operation input unit 106b for recognizing that the electrostatic touch pad 14 has been pushed. The key input unit 106a can recognize that a plurality of keys including digit keys, letter keys, and functional keys, e.g., for determining and interrupting mail editing have been pushed. It conveys the recognition signal that recognizes a key to the controller 101 correspondingly to the input of key 6 input operated by the user, and the controller 101 stars the respective operation. Furthermore, the music operation input unit 106b can also recognize the operation when music reproduction, stop, pause, fast forward, rewinding, tune selection, sound volume adjustment, and Music Player start-stop are carried out via the electrostatic pad 14.

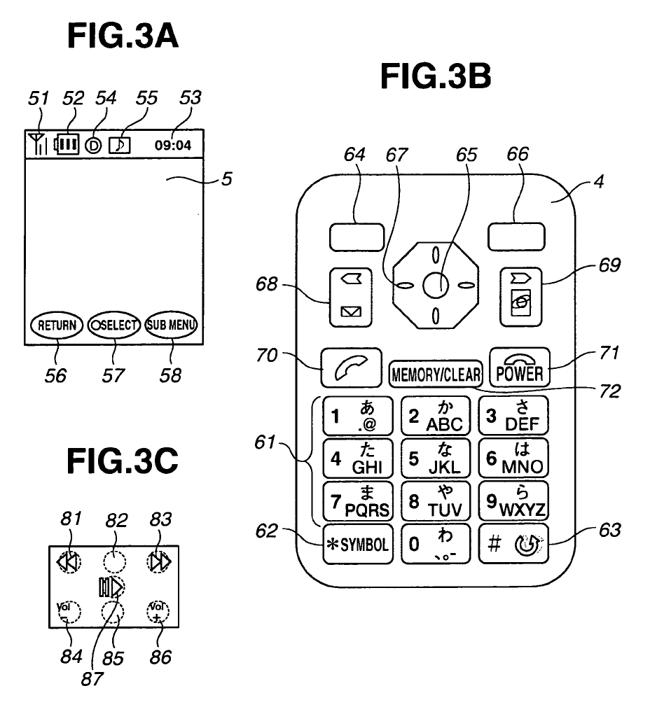

FIG. 3 shows an example of display on the display 5 of the cellular phone 1, an arrangement example of keys 6, and an arrangement example of operation zones of the electrostatic touch pad 14 in which FIG. 3A shows an example of display on the display 5, FIG. 3B shows an arrangement example of keys 6, and FIG. 3C shows an arrangement example of operation zones of the electrostatic touch pad 14. As shown in FIG. 3A, in the uppermost row (referred to hereinbelow as “upper pictogram row”) of the display 5 of the cellular phone 1, there are displayed an antenna pictogram 51 showing the present level of sensitivity of the antenna 117, a battery pictogram 52 showing the present remaining battery charge of the cellular phone 1, a time display 53 displaying current time, a BT icon 54 displayed when BT is activated, and a music icon 55 displayed when, for example, a Music Player (denoted hereinbelow by “MP”) is activated. In the BT icon 54, the icon background is displayed with blue color (the ellipse in the figure is blue) during BT connection and with white color (the ellipse in the figure is white) during server operation (BT connection standby state). Further, when BT connection is not performed (including the case where the BT link is cut off), control is so conducted that the icon is not displayed. As mentioned above, the music icon 55 is displayed when MP is activated, but it can be also displayed during background reproduction (referred to hereinbelow as BGM). In other cases, control with the controller 101 is so conducted that the icon is not displayed.

In the lowermost row (referred to hereinbelow as “lower pictogram row”) of the display 5 of the cellular phone 1, of the presently displayed functions, simple explanation is provided to functions executed when a soft key left 64, confirmation key 65 (central portion of a cross-like key 67), and soft key right 66 are pushed. Thus, for the soft key left 64, the explanation is displayed at the lower left pictogram 54, for the confirmation key 65, the explanation is provided at the central lower pictogram 55, and for the soft key right 66, the explanation is provided at the lower right pictogram 56. For example, in the case of the display shown in FIG. 3A, if the soft key left 64 is pushed, the “RETURN” function is executed, and if the confirmation key 65 is pushed, the function that is presently in focus (not shown in the figure) can be selected. Furthermore, if the soft key right 66 is pushed, “submenu” is displayed.

As shown in FIG. 3B, the lower key section 4 comprises the following keys 6: digit keys 61, a “*” key 62, a “#” key 63, a soft key left 64, a confirmation key 65, a soft key right 66, a cross-like key 67, a mail key 68, a browser key 69, a telephone key 70, a power source key 71, and a clear key 72. In addition to digits, Japanese alphabet KANA symbols, various signs, and English alphabet letters are allocated to the digit keys 61. For example, digit “1”, Japanese KANA symbols [symbol] “(respectively represented by “a”, “i”, “u”, “e” and “o” in English alphabet letters), and signs “,”, “@” are allocated to the key “1”. Digit key “2”, Japanese KANA symbols [symbol] (respectively represented by “ka”, “ki”, “ku”, “ke” and “ko” in English alphabet letters), and alphabet letters “A”, “B”, “C”, “a”, “b”, and “c” are allocated to key “2”. Furthermore, “*” is allocated to the “*” key 62, and, in a letter input state, a symbol list and pictogram list can by called out by the key 62. Furthermore, “#” is allocated to the “#” key 63, and in a letter input state, the toggle of letter input with the digit key 61 can be reversed by the key 63.

The cross-like key 67 comprises an upper key, a lower key, a left key, a right key, and the confirmation key 65 and can move the cursor in the up-down and left-right direction. In addition, if the confirmation key 65 is pushed, various functions can be confirmed. Furthermore, the mail key 68 can call out a mail send/receive function. The browse key allows for connection to Web or the like.

The telephone key 70 is mainly used when a call is received or when a usual signal is generated. The power source key 71 is mainly used for power source ON and OFF, and also when the call is completed or when a function or editing is completed. The clear key 72 is mainly used when a function or editing is cleared and to erase a letter in case of letter input. Furthermore, if the clear key 72 is pushed in a standby screen, a memo register can be called out.

Furthermore, as shown in FIG. 3C, the electrostatic touch pad 14 appears to be a single touch pad, but sensors 81 to 87 are provided in seven places shown by dot line circles in FIG. 3C, and if the sensor 81 detects that the user has touched the pad close to the location of sensor 81, a rewind function is executed. Similarly, if the sensor 83 detects that a sensitive zone was touched, a fast forward function is executed, if the sensor 84 detects that a sensitive zone was touched, a one-level sound volume down operation is executed, if the sensor 86 detects that a sensitive zone was touched, a one-level sound volume up operation is executed, and if the sensor 87 detects that a sensitive zone was touched, a reproduction operation is executed in a state where the music was stopped and a pause operation is executed in a state where the music was reproduced. Furthermore, if the sensors 81, 82, 83 are detected to be touched in the order of description within a prescribed interval (the user performs a tracing operation from the left to the right), then search of several tunes forward is executed. Conversely, if the sensors 83, 82, 81 are detected to be touched in the order of description within a prescribed interval (the user performs a tracing operation from the right to the left), then search of several tunes backward is executed. Furthermore, if the sensors 84, 85, 86 are detected to be touched in the order of description within a prescribed interval (the user performs a tracing operation from the left to the right), then the sound volume up operation is executed through several levels. Conversely, if the sensors 86, 85, 84 are detected to be touched in the order of description within a prescribed interval (the user performs a tracing operation from the right to the left), then the sound volume down operation is executed through several levels.

Furthermore, as described hereinabove, sensors 11a to 11d for detecting the state of the upper case section 2 and lower case section 4 are provided in the upper case section 2 and lower case section 4. Those sensors 11a to 11d comprise, for example, magnetic sensors, and the sensors output detection signals in proximal state within a fixed range. Of the sensors 11a to 11d, a pair of sensors 11a and 11b detect whether or not the upper case section 2 and lower case section 4 lie one on top of another.

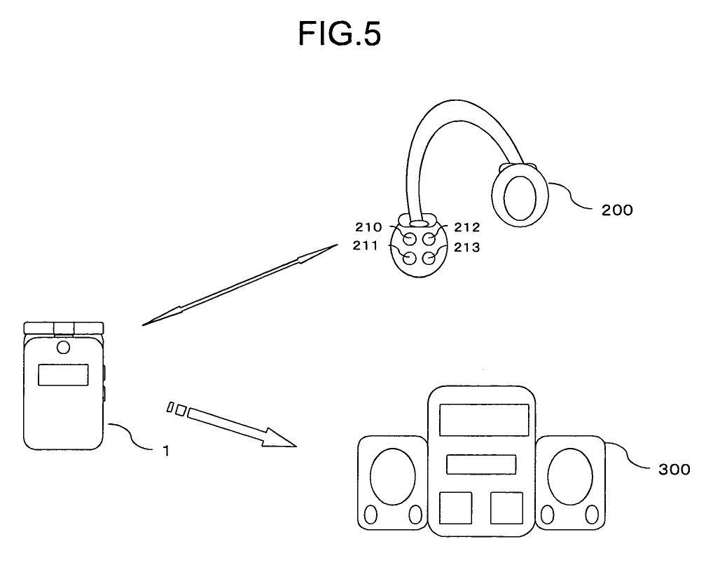

FIG. 5 illustrates an embodiment of a system using a cellular phone 1 carrying the BT, a BT headphone 200 carrying the BT, and a BT component 300 carrying the BT. The cellular phone 1 also can issue a processing request (cry-out operation) which is necessary for establishing connection of BT communication and can conduct processing necessary for establishing the communication and respond (server operation) to the connection request from other communication terminals.

Furthermore, the cellular phone 1 can be connected to other communication terminals carrying the BT, but there are BT communication terminals (for example, the BT headphone 200) capable of conducting both the cry-out operation and the server operation and BT communication terminals (for example, the BT component 300) capable only of conducting the server operation and incapable of conducting the cry-out operation. In other words, the cellular phone 1 and BT headphone 200 can by themselves conduct the connection operation to other BT devices and, obviously, also can receive such a connection. However, the BT component 300 cannot by itself connect to other BT devices and can only receive the BT connection.

The BT headphone 200 shown in FIG. 5 comprises a power source key 210 capable of switching the power source ON/OFF, a reproduction key 211 for reproducing musical information received by BT communication, a stop key 212 for stopping music during reproduction, and a pause key 213 for pausing/restarting the music during reproduction.

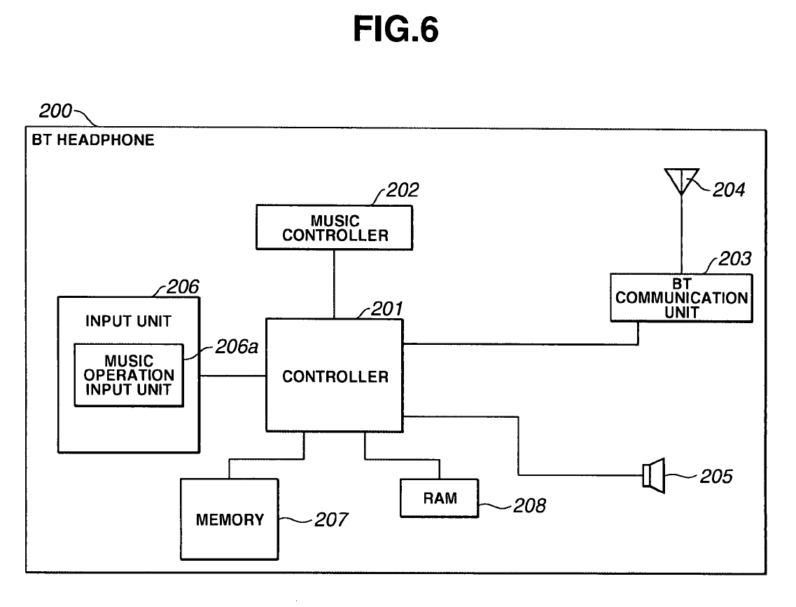

FIG. 6 is a block-diagram illustrating schematically the configuration of the BT headphone 200. Inside the BT headphone 200 there are provided a controller 201 for controlling the entire BT headphone 200, a music controller 202, a BT communication unit 203, a BT antenna 204, a speaker 205, an input unit 206, a nonvolatile memory 207 comprising ROM or the like, and a volatile RAM 208 for temporary memory; all the units are controlled by the controller 201.

The memory 207 stores a program executed by the controller 201 and various information data.

The input unit 206 has a function of detecting the input of the power source key 210, etc., and sending this signal to the controller 201. Furthermore, the input unit 206 also comprises a music operation input unit 206a for receiving the input of music reproduction operation of the reproduction key 211, stop key 212, and pause key 213.

The BT communication unit 203 controls the transmission and reception of data via the BT antenna 204 with the BT connection system. Furthermore, the operations of searching the peripheral BT-communicable communication terminals and establishing links prior to data transmission and reception are also controlled in a well-known manner by the BT communication unit 203.

The music controller 202 has a function of decoding and reproducing music files that were transmitted from other BT devices when connection with other BT devices is established and music reproduction is conducted with the BT headphone 200.

The present invention assumes that it is necessary to start the BT before activating the MP and to obtain a list that has to be connected by BT connection with the cellular phone 1. If the confirmation key 65 of the cellular phone 1 is pushed, a menu screen (not shown in the figures) is displayed. In this state, if a BT menu is selected from the menu and a search operation is selected from the selected menu, the search is conducted. At this point in time, a BT table (not shown in the figures) that stores the device name information, address information, device type information, and corresponding service information of a plurality of BT-communicable communication terminals present in the peripherals is loaded from those devices.

Then, the corresponding service of the loaded BT table is checked, which service can be executed is examined, and a communicable remote device is verified. If a communicable remote device is present, then one list of remote devices (a list based on the BT table of respective peripheral devices). is displayed on the display unit of a wireless communication unit. This list information is then stored in the BT connection list memory 115b.

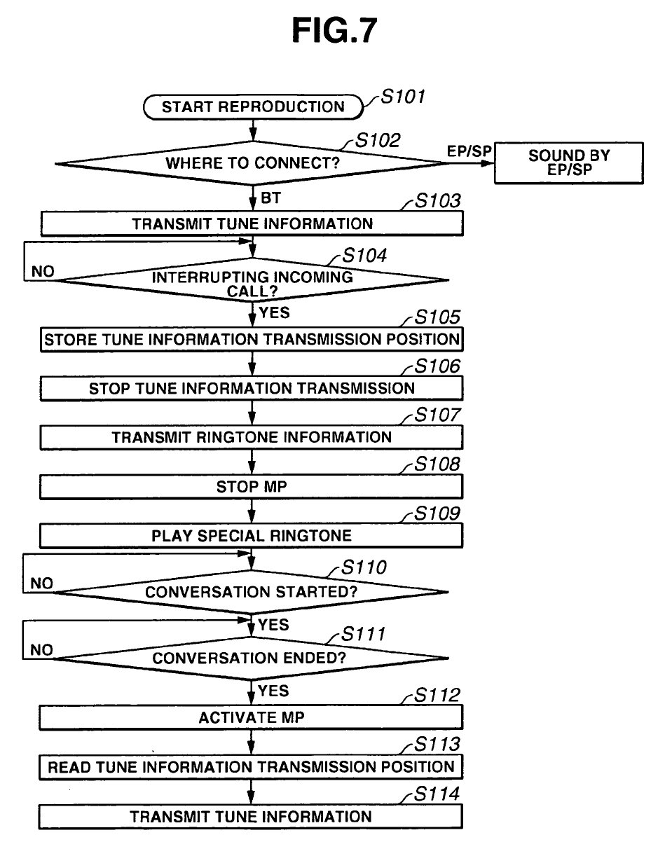

As descried above, it is necessary to obtain a list that has to be connected by BT connection with the cellular phone 1. Together with this operation, exchange of PIN codes for mutual authentication of the cellular phone 1 and BT headphone 200 is conducted at this point in time. Furthermore, a setting can be made such that the exchange of PIN codes is not conducted at a stage of obtaining the list, and the PIN codes may be exchanged at a stage of establishing communication in the below-described flow shown in FIG. 7 to FIG. 11.

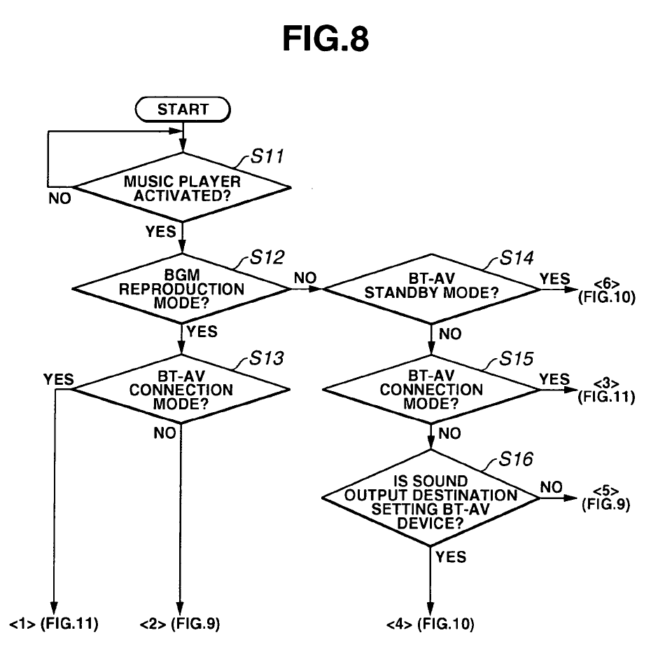

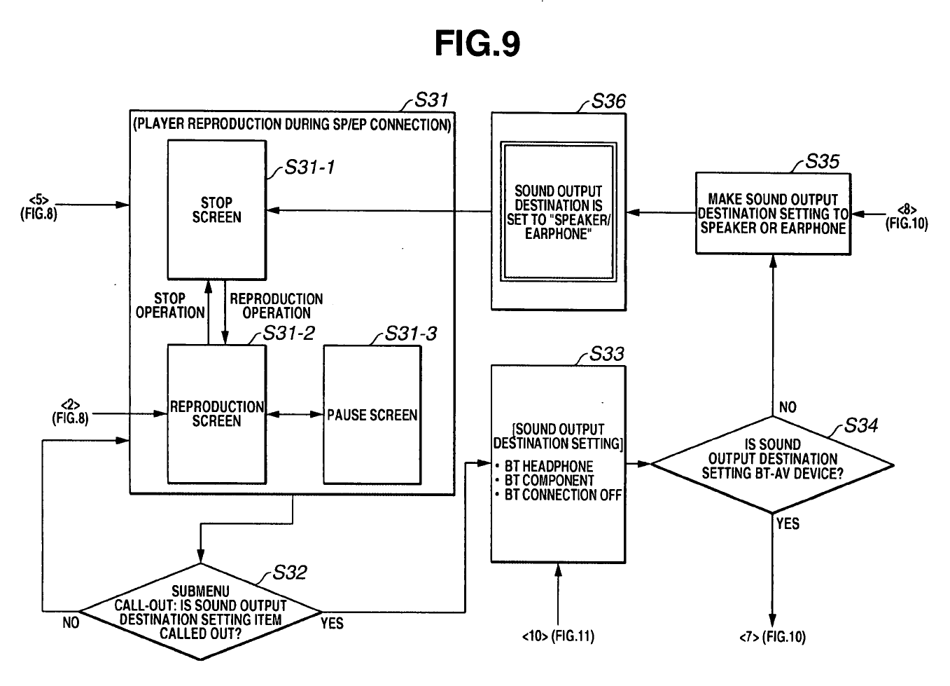

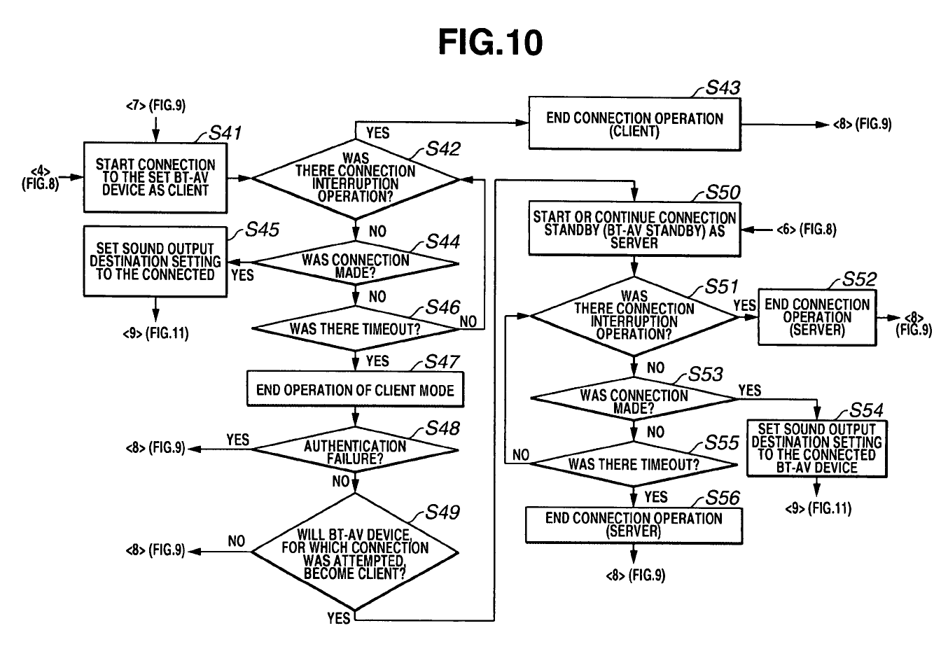

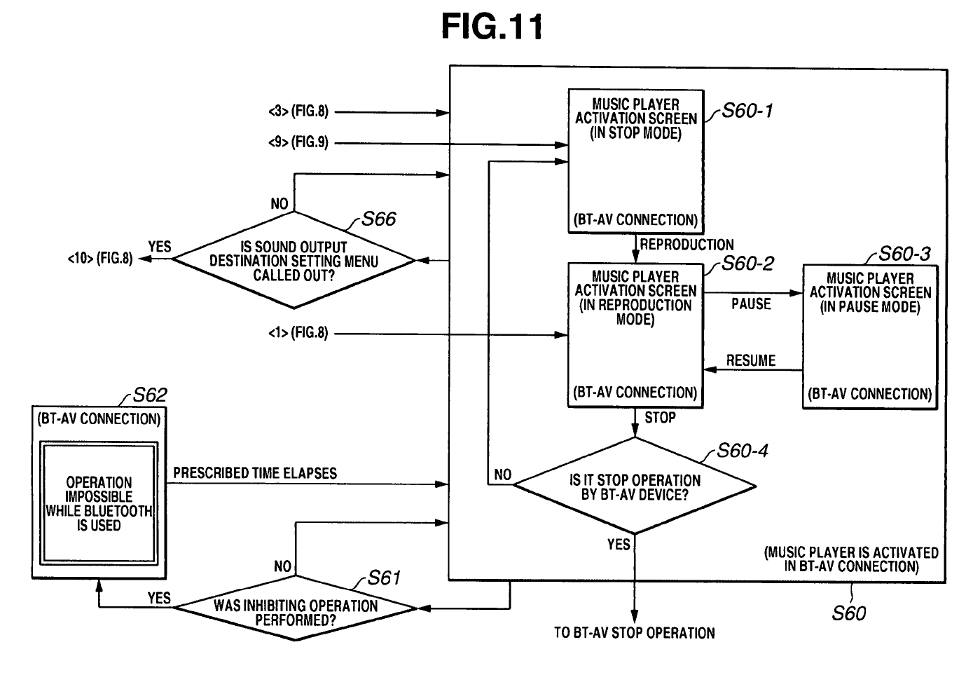

The flow of operations executed when music reproduction is conducted with the cellular phone 1 of the embodiment of the present invention will be explained below with reference to FIGS. 7 to 12. The operation of the cellular phone 1 of the present invention can be divided as follows.
(1) Operations conducted when there is an incoming call during BT-AV connection and tune reproduction (FIG. 7).
(2-1) MP start operation (FIG. 8).
(2-2) BT-AV connection (connection between the cellular phone 1 and the communication terminal carrying the BT; same hereinbelow) start operation (FIG. 10).
(2-3) MP operation—speaker/earphone output (abbreviated hereinbelow as SP/EP output) (FIG. 9).
(2-4) MP operation—BT-AV connection device output (FIG. 11).

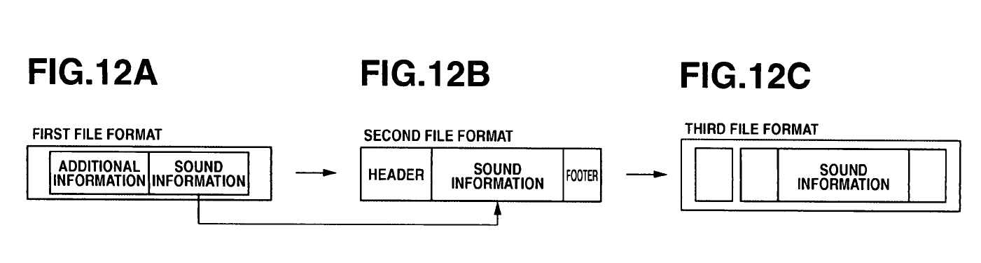

Each of the aforementioned operations will be described hereinbelow separately. The explanation will be conduced with appropriate reference to FIG. 12 and FIG. 13. FIG. 12 serves to explain the tune information recorded in the tune information memory 15a in the cellular phone 1, and FIG. 13 illustrates an example of a display screen of the display 5 when the cellular phone 1 operates.

(1) Operations Conducted When There is an Incoming Call During BT-AV Connection and Tune Reproduction (FIG. 7)

The operation will be overviewed and the operations carried out when there is an incoming call during BT-AV connection will be explained. This is one of the essential points of the present invention. FIG. 7 is a flowchart illustrating the operations conducted when there is an incoming call during BT-AV connection and tune reproduction. First, if the reproduction operation of tune information stored in the tune information memory 115a is performed by the user (step S101; described in detail hereinbelow), whereabouts of the output of the sound of the melody reproduced based on the below-described operations (2-1) through (2-3), e.g., BT-AV connection procedure, are determined based on the sound output setting information memory 115c (step S102; described in detail hereinbelow). When the sound output destination is SP/EP, the output is carried out to the speaker 109 or earphone, respectively (“SP/EP” of step 102). In this case, if there is an interrupting incoming call, the reproduction of tune is stopped and the usual ringtone is outputted.

On the other hand, when the sound output destination is BT (“BT” in step S102), the tune information (first file format) is read from the tune information memory 115a and the music controller 105 takes out the information (second file format) relating to the sound information that will be reproduced (shown in FIG. 12B from the tune information (first file format) shown in FIG. 12A. The information relating to the sound information that was converted into the second file format for reproduction is sent to the BT communication unit 118. The BT communication unit 118 attaches information (header and the like) so as to match a file format (third file format) of the form suitable for BT communication, as shown in FIG. 12C, opens the antenna 119 and transmits the file in the third file format to a BT-AV device (for example, the BT headphone 200) by the BT. In the BT-AV device (BT headphone 200), the transmitted file is reproduced in the BT headphone 200 by decoding with the music controller 202 (step S103). Furthermore, it is preferred that control be so conducted in the cellular phone 1 that the reproduced tune information be stored on the RAM by the second file format till the reproduction of one tune (or the prescribed number of tunes), which is being reproduced, is completed, and that this information be deleted once the tune reproduction is completed.

Now, FIGS. 12A to 12C will be explained. FIG. 12A illustrates in a simple manner the stage of converting the tune information into the first file format. In the tune information, the “sound information” relating to the sound itself and the “additional information” comprising the information on image data and musical tune (tune name and the like) associated with the sound information are combined in one file. Usually, the file is stored in the tune information memory of the memory 115a in this first file format. FIG. 12B illustrates in a simple manner the stage of converting the tune information into the second file format. This file comprises the “sound information” of the first file format and a header and a footer comprising information based thereof. FIG. 12C illustrates in a simple manner the stage of converting the tune information into the third file format. The third file format is a file format having added thereto the information necessary to obtain the information in the second file format in the form suitable for BT communication.

Then, it is determined whether or not there is an interrupting incoming call to the cellular phone 1 during tune information reproduction in step S103 (step S104). When there is an interrupting incoming call (“Yes”), the music controller 105 determines the music information transmission end position and stores it in the RAM 111 (step S105). The transmission of the tune information that is being transmitted is thereafter stopped by the present BT (step S106).

Then, the ringtone information stored in the ringtone memory 115d located in the memory 115 is read, the music controller 105 converts the first file format into the second file format and then to the third file format, similarly to the tune information and transmits the file to the BT-AV device. In the BT-AV device, the sound output is conducted (step S107). Furthermore, it is preferred that the ringtone information be stored in advance in the first format in the ringtone memory 115d, but may be also stored in the second file format or third file format and in the form of information conforming thereto. Furthermore, only the ringtone information corresponding to a short time interval is held and an interval merely allowing the user to recognize the ringtone information is allocated (for example, about 500 MS). This ringtone preferably holds information other than the usual ringtone information and may be of one kind or of a plurality of kinds for each group or individual set in a phone register.

Then, the controller 101 stops the MP function (step S108) and actuates the usual ringtone from the speaker 109 at the cellular phone 1 (step S109). At this time, ringtones that were set individually in the usual manner (set in the phone register not shown in the figure) is actuated, or a ringtone specific for a group is actuated, or vibrations are induced according individually set vibration settings in case of a manner mode, or vibrations are induced according to vibration settings specific for a group.

Then, whether or not the telephone key 70 was pushed and the phone call operation was performed is determined (step S110). If the telephone operation activated by pushing the telephone key 70, etc., is performed, the talking is started (“Yes” in step 110). Whether or not the talking has ended (step S111) is then determined, and if the call end operation is performed, for example, by pushing the call end key 71, the call ends (“Yes” in step S111). The MP function is then activated again and the below-described MP activation operation is carried out (step S112). At this time, the transmission end position information of the tune information stored in the RAM 111 in step S105 is read (step S113), and the music controller 105 starts reproduction from the middle stage of the tune based on the transmission end position information of the tune information stored in the RAM 111 (step S114). For example, the output to the speaker 109 or speaker 205 in the BT-AV device may be conducted again from the tune several seconds before the transmission end position information of the tune information stored in the RAM 111, or the output may be restarted from the transmission end position information of the tune information. In another possible configuration, the reproduction is not started immediately and the tune is held in the RAM 111 based on the second file format so that the reproduction is started immediately from the very beginning of the tune that has been reproduced, if the reproduction key 211 of the BT headphone 200, key 6 of the cellular phone, or electrostatic touch pad 14 is pushed.

The MP stop and MP activation described in step S108 and step S112 can be also conducted in stop (end) state—restart state in a background of the call reception—calling operations, without stopping and activating the program itself.

(2-1) MP Start Operation

The MP start operation will be explained below. FIG. 8 is a flowchart illustrating the operations conduced during MP activation. Whether the Music Player (MP) has been activated from the usual standby state of the cellular phone 1 (step S11) is initially determined. Further, examples of MP activation methods include calling out from the menu by pushing the confirmation key 65 (MP activation that is not accompanied by reproduction), calling out by pushing the side key 7 within the prescribed interval (MP activation that is accompanied by reproduction), and calling out by pushing the electrostatic touch pad 14 within the prescribed interval (MP activation that is accompanied by reproduction). The activation that is accompanied by reproduction is, for example, an activation in which reproduction is carried out simultaneously with the activation; the activation that is not accompanied by reproduction indicates the case where reproduction is not carried out simultaneously with the activation (including a pause in the course of the procedure in which the previous tune reproduction was conducted).

Further, if the MP is activated (“Yes” in step S11), then it is determined whether the music is being reproduced in the BGM (step S12). When the music is determined to be reproduced in the BGM (“Yes”), it is determined as to whether the BT-AV connection is being made by the BT (step S13). Furthermore, when the BGM reproduction was not determined in step S12 (“No”), it is determined whether the system is in a BT-AV standby mode (step S14).

Then, when the system was determined in step S13 to be in a BT-AV connection mode (“Yes”), the BGM reproduction of tune information is simply shifted to the MP, that is, to the foreground reproduction (referred to hereinbelow as FGM) and the music continuous to flow from the BT-AV device that has been outputting the music, without change, even in the middle of the tune (“Yes” direction of step S113; <1> transition to step S60-2 in FIG. 11).

On the other hand, when the system was determined in step S13 not to be in the BT-AV connection mode (“No”), the tone information is reproduced by player operation with SP/EP output settings. In this case, too, the BGM reproduction in the SP/EP output simply shifts to the FGM reproduction, and music output is carried out uninterrupted from a speaker or earphone that has been outputting the music, without change, even in the middle of the tune (“No” direction of step S13; <2> advancement to step S31-2 in FIG. 9).

When the system was determined to be in a BT-AV standby mode (“Yes” in step S14) as a result of determining in step S14 as to whether or not it is in a BT-AV standby mode, the BT-AV standby is continued, that is, connection wait as a server is continued (<6>, step S50 in FIG. 10).

On the other hand, when the system was determined not to be in a BT-AV standby mode (“No” in step S14) as a result of determining in step S14 as to whether or not it is in a BT-AV standby mode, whether or not it is in a BT-AV connection mode is determined (step S15).

Further, when the system was determined to be in a BT-AV connection mode (“Yes” in step S15), the player operations are carried out with respect to the output destination which is in the BT-AV connection (<3>, step S60 in FIG. 11). When the player operations are carried out, for example, in the case of MP activation that is accompanied by reproduction during MP activation in step S11, the player operation (reproduction) is carried out (step S60-2), and in the case of MP activation that is not accompanied by reproduction, the player operation (pause) is carried out (step S60-3). This transition is merely an example and the appropriate setting may provide for transition to any state (reproduction, stop, pause) in the frame of step S60 shown in FIG. 11.

On the other hand, when the system was determined in step S15 not to be in the BT-AV connection mode (“No” in step S15), the sound output destination setting stored in the sound output setting information memory 15c is read and whether the setting has been made to a BT-AV connectable device is determined (step S16).

When the sound output destination setting stored in the sound output setting information memory 15c was determined in step S16 not to be that of a BT-AV connectable device (“No”), the player operations are carried out by the connection via SP/EP (<5>, advancement to S31 in FIG. 9). When player operations are carried out, for example, in the case of MP activation that is accompanied by reproduction during MP activation in step S11, the player operation (reproduction) is carried out (step S31-2), and in the case of MP activation that is not accompanied by reproduction, the player operation (pause) is carried out (step S31-3). This transition is merely an example and the appropriate setting may provide for transition to any state (reproduction, stop, pause) in the frame of step S31 shown in FIG. 9.

On the other hand, when the sound output destination setting stored in the sound output setting information memory 15c was determined in step S16 to be that of a BT-AV connectable device (“Yes” in step S16), the BT-AV connection is initiated as a client to the BT-AV connectable device that was set (<4>, advancement to step S41 in FIG. 10). In this case, because the sound output destination setting during previous activation of the player is stored in the sound output setting information memory 115c, this setting is employed as is. Therefore, the user is saved the trouble of making settings each time the player is activated.

Further, the MP start operation is not limited to the activation according to the procedure described in the flowchart shown in FIG. 8. In other words, for example, the design may be such as to make a transition to <1> (FIG. 11) when the system is in the BGM reproduction mode and BT-AV connection mode when the MP was activated in step S11. Similarly, the design may be such as to make a transition to <4> (FIG. 10) in the case where the system is not in the BGM reproduction mode, not in the BT-AV standby mode, and not in the BT-AV connection mode when the MP was activated in step S11 and where the setting of the sound output setting information memory 115c has been set to a BT-AV communicable device.

(2-2) BT-AV Connection Start Operation

The BT-AV connection start operation will be explained below by using FIG. 10. FIG. 10 is a flow chart relating to initiation of the BT-AV connection start operation. The BT-AV connection start operation is carried out: (A) in the case where the system is not in the BGM reproduction mode, not in the BT-AV standby mode, and not in the BT-AV connection mode when the MP was activated in step S11 (step S11) and also the setting of the setting of the sound output setting information memory 115c has been set to a BT-AV connectable device (transition from <4> in FIG. 8), and (B) in the case where the sound output destination setting was changed during MP activation by the SP/EP connection and this change was made to a BT-AV connectable device (transition from <7> in FIG. 9).

First, if the BT-AV connection start operation is carried out in the above-described manner, the BT-AV connection operation (for example, connection by the AV profile) is started as a client with respect the BT-AV connectable device that was set as the sound output destination (the explanation hereinbelow will be conduced with respect to setting to the BT headphone 200) (step S41). Then, it is determined whether or not the connection abort operation has been performed with the clear key 72 or power source key 71 (step S42). If the connection abort operation has been performed (“Yes”), the connection with the BT headphone 200 is ended (step S43). The sound output setting is then set to the SP/EP connection (transition to <8> in FIG>9).

On the other hand, when the connection abort operation was not detected, whether or not the BT-AV connection was made by the client operation is determined (step S44).

When the BT-AV connection was made, the settings of the sound output destination information stored in the sound output setting information memory 115c are rewritten into the connected BT-AV device (in this case, the BT headphone 200) (step S45). The player operation (stop) is thereafter carried out by the BT-AV connection (<9>, transition to step S60-1 in FIG. 11).

On the other hand, if the establishment of the BT-AV connection was not determined (“No” in step S44), whether or not the prescribed interval has elapsed (whether there is a timeout) after the connection a client has been started is determined, and when there was no timeout, the processing routine again returns to step S42 (“No” in step S46). If the timeout interval is too short, the connection ratio is decreased, and if the timeout interval is too long, the connection waiting time it too long, both scenarios being undesirable for the user. Accordingly, it is preferred than the timeout time be several seconds (about 5 sec).

When the connection as a client was not made before the prescribed time (time to timeout) in steps S44 and S46 (“Yes” in step S46), the operation of BT-AV connection for which connection as a client was attempted is ended (step S47). Then, it is determined whether or not the connection failure caused by authentication failure (authentication of the cellular phone 1 and BT-AV device based on PIN codes) at the time the connection was attempted is the reason for the connection failure (step S48). This is because when the connection failure is caused by the authentication failure, it is necessary to receive the PIN codes again and conduct authentication with the BT-AV device.

When the connection failure is not caused by the authentication failure, (“No” in step S48), it is determined whether or not the connected BT-AV device (BT headphone 200) itself is a device operable as a client (step S49). A method for determining as to whether the device is operable as a client will be described below.

When the BT-AV device for which the connection was attempted is determined as a device that will be a client (“No” of step S49), then the BT-AV connection wait as a server is started (step S50). Furthermore, only the BT-AV device for which connection as a client has been heretofore attempted (in this case, the BT headphone 200) may be set as a BT-AV connectable device that waits connection as a server at this time, or the connection wait may be carried out with respect to all the BT-AV devices stored in the BT connection list memory 115b (in this case, not only the BT headphone 200, but also other devices such as BT component 300 are included).

Then, if the BT-AV connection wait operation as a server is carried out in step S50, it is thereafter determined whether or not the connection abort operation by the clear key 72 or power source key 71 has been performed (step S51).

When the connection abort operation has been performed (“Yes), the connection with the BT headphone 200 is ended (step S52). Furthermore, the sound output setting is set as a SP/EP connection (transition to <8> in FIG. 9).

On the other hand, is the connection abort operation has not been detected, then whether or not the BT-AV connection was made by the server operation is determined (step S53).

When the BT-AV connection was made, the setting of the sound output destination information stored in the sound output setting information memory 115c is rewritten as the connected BT-AV device (step S54). Then, the player operation (stop) is carried out by the BT-AV connection (<9> transition to step S60-1 in FIG. 11).

On the other hand, if it is not determined that the BT-AV connection was made (“No” of step S53), then whether or not the prescribed interval has passes after the connection as a client was started (is there a timeout) is determined, and when there is no a timeout, the processing routine again returns to step S51 (“No” in step S55). Furthermore, after the guidelines have been displayed for the user in step S50, it is necessary to wait for a time sufficient for the user to switch on the power source of the connection destination. Therefore, the timeout interval during connection wait as a server is preferably from several tens of seconds to about 1 min.

In the case where no connection as a server was made within the prescribed interval (timeout interval) in steps S53, S55 (“Yes” of step S55), the server mode operation is ended (step S56). Furthermore, the sound output setting is set as a SP/EP connection (<8> transition to step S35 of FIG. 9).

In the case where the BT-AV connectable device for which the connection was attempted is determined not to be a client (“No” in step S49) when the failure cause was an authentication failure in step S48 (“Yes” in step S48), the controller 101 sets the sound output setting as the SP/EP connection (<8> transition to step S35 of FIG. 9).

Furthermore, making a <8> (FIG. 9) transition and setting to the SP/EP connection is not the only option when the connection failure cause was an authentication failure in step S48 (“Yes”). Thus, settings may be such that when the connection failure cause is an authentication failure, a PIN code for PIN code authentication of the BT-AV device for which this connection was attempted is received again and the processing routine then returns again to step S41 and the connection to this BT-AV device as a client is again attempted.

In this BT-AV connection operation, initially the connection as a client was implemented, and a server mode operation was implemented in the case of a failure. However, the same effect can be obtained if those operations are transposed with each other. Furthermore, even when the cellular phone 1 and the BT-AV device capable of operating as a client (for example, the BT headphone 200) implement the client connection operation at the same time, the connection of communication can be established by repeating the operations of the present embodiment.

(Determination Whether or Not the Device That Can Be BT-AV Connected is a Client)

Methods for determining whether or not the BT-AV device that was attempted to be connected in step S49 becomes a client will be described below in greater detail. The following four methods (A) to (D) will be considered and the procedure will be implemented by each method and by combination thereof.

(A) No Determination is Made, and the Device is Assumed to Become a Client.

When a transition is made to step S49, no determination is carried out, the device is assumed to be a client, and a transition is always made to step S50.

(B) When a Peripheral Device List is Registered, Information Indicating Whether or Not the Device Will Become a Client is Set at the Same Time

As described hereinabove, the peripheral device list has to be obtained and stored in the BT connection list memory 115b before the MP is activated, and when this list is obtained (displayed), information relating to each BT-AV connectable device and indicating whether or not the device can be connected as a client is associated with respective device information and stored in the BT connection list memory 115b, and when a transition is made to step S49, this information is read and a decision is made whether the device will become a client.

(C) Determination from Information Loaded When the Peripheral Device List is Searched

The peripheral device list is searched and service information (for example, in the BT standard, it is a service code stored in the location called “SDDB”) is included in the information that will be loaded; whether or not the device will be a client is determined based on the Supported Features information of this service information. This Supported Features information describes the information indicating a class of communication terminals to which this device belongs and is set in the memory 115 of the cellular phone 1 correspondingly to this class by associating the information on this class with the information indicating in advance whether the device will be a client (not shown in the figure). Whether or not the connected BT-AV device will be become a client is determined based on this information. More specifically, storage in the memory 115 is conducted by associating with the respective information so that if a flag indicating a Headset is set in advance in the Supported Features Information, the BT-AV device is determined to become a client and a server, and when other flags are set, the BT-AV device is determined to be necessarily a server. When the determination of step S49 is made, whether or not the device for which the connection was attempted will become a client is determined base on this associated information.

In addition, the information on whether or not the BT-AV device itself will become a client is introduced into a preset area (for example, in the BT standard, the data of “Provider Name” of the service information) of the service information, and whether or not the respective BT-AV devices will become clients can be determined based on the service information described in the BT table of the actual cellular phone 1. When the determination of step S49 is made, whether or not the device will become a client is determined based on the information in this BT table.

(D) When Connection is Made from a BT-AV Device With a Client, the Information Indicating That the Device Can Be a Client is Recorded and the Determination is Made Based on This Information

In the case where a BT-AV connectable device (for example, the BT headphone 200) was connected as a client when the BT connection was made with the cellular phone 1 and the BT-AV connectable device stored in the BT connection list memory 115b (the case where the cellular phone 1 was connected as a server), the connected BT-AV connectable device (for example, the BT headphone 200) that was stored in the BT connection list memory 115b and the information indicating that it can be a client are associated and stored. Furthermore, whether or not the information indicating that the device can be a client has been recorded is determined when the possibility of becoming a client is determined in step S49.

(2-3) MP Operation and SP/EP Output

The MP operation and SP/EP output operation (abbreviated hereinbelow as SP/EP output operation) will be explained below with reference to FIG. 9. FIG. 9 is a flowchart relating to reproduction of a tune stored in the tune information memory 15 a by the SP/EP output.

First, the SP/EP output operation is carried out A when the MP is activated and the system is not in the BGM reproduction mode or BT-AV connection mode (<2> FIG. 8) and B in the case where the MP is activated, the system in not in the BGM reproduction mode, not in the BT-AV connection standby mode, and not in the BT-AV connection mode and also the sound output destination setting is not the BT-AV device (<5> FIG. 8) in the MP start operation.

If the above-described operations are performed in the SP/EP output operations, the reproduction (step S31-2)—stop (step S31-1)—pause (step S31-3) of the tune from the speaker 109 are conducted. Those operations are together referred to as SP/EP player reproduction (step S31). Furthermore, the transition between the tune reproduction (step S31-2)—stop (step S31-1)—pause (step S31-3) operations can be made by operating the keys 6 and electrostatic touch pad 14. In the course of SP/EP player reproduction, the controller 101 calls out the submenu activated when the right soft key 66 is pushed and determines as to whether or not the sound output destination setting item screen has been called out (step S32). In the case where the controller determined that the sound output destination setting item screen has not been called out, the SP/EP player reproduction is continued (“No” in step S32).

On the other hand, when the controller 101 determines that the sound output destination setting item screen has been called out, it displays on the display 5 the display described in step S33 of FIG. 9 (step S33). Furthermore, as items that are displayed on the display 5, all the BT-AV devices and “BT connection OFF” of the peripheral device list stored in the BT connection list memory 115b are displayed. When the sound output destination is the present BT-AV device, a display may be made where only the “BT connection OFF” can be selected, and when the present sound output destination is SP/EP, the display may indicate that only the “BT connection OFF” cannot be selected. Furthermore, it is also possible to display that only the present sound output destination cannot be selected.

When any of the sound output destination settings was selected n step S33, the controller 101 determines whether or not this selected sound output destination setting is a BT-AV device (step S34). When the selected sound output destination setting is a BT-AV device (“Yes” of step S34), the BT-AV connection is started for this device (<7> FIG. 10).

On the other hand, when it wag determined that the selected sound output destination setting was not a BT-AV device (“No” in step S34), the sound output destination setting is set to a speaker or earphone (SP/EP). This is stored in the sound output setting information memory 115c. The controller 101 then displays the display indicated in step S36 on the display 5. A transition is thereafter made to a tune reproduction operation (stop) with the SP/EP output (step S31-1).

(2-4) MP Operation—BT-AV Connection Device Output

The MP operation—BT-AV connection device output (denoted hereinbelow as BT-AV output) will be explained below. FIG. 11 is a flowchart relating to the MP operation—BT-AV output.

First, the BT-AV output operation is carried out (A) when the MP is activated and the system is in the BGM reproduction mode and BT-AV connection mode (<1> FIG. 8) and (B) in the case where the MP is activated, the system in not in the BGM reproduction mode, not in the BT-AV connection standby mode and in the BT-AV connection mode (<3> FIG. 8), and (C) the BT-AV output was successfully connected (<9> FIG. 10 step S45—step 54) in the MP start operation.

If the above-described operations are performed in the BT-AV output operations, the reproduction (step S60-2)—stop (step S60-1)—pause (step S60-3) of the tune from the BT-AV device (for example, the speaker 205 of the BT headphone 200) are conducted. Those operations are together referred to as BT-AV player reproduction (step S60). Furthermore, the transition between the tune reproduction—stop—pause operations is described below.

First, if the reproduction operation (for example, the zone of the sensor 87 of the electrostatic touch pad 14 is pushed) is performed in a stop mode, a transition is made to the reproduction. Furthermore, if the pause operation (for example, the pause key 213 of the BT headphone 200 is pushed) is performed during reproduction, a transition made to a pause, and the reproduction is restarted (for example, the zone of the sensor 87 of the electrostatic touch pad 14 is pushed) is performed, a transition is made to the reproduction operation.

If a stop operation is performed during reproduction, then whether or not this stop operation is from a BT-AV device is determined (step S60-4). If it is not a stop operation from a BT-AV device and is a stop operation from the cellular phone 1 (“No” in step S60-4), a transition is made to the stop operation (step S60-1).

On the other hand, if a stop operation (for example, a stop key 212 of the BT head phone 200 is pushed) from a BT-AV device is performed during reproduction, the BT-AV connection is cut off, the client operation or server operation is ended, and a transition is made to a BT-AV end operation.

Then, it is determined (step S61) as to whether or not the inhibiting operation (for example, the operation such that even if, e.g., the sound volume adjustment operation and fast forward and rewind operations are preformed with the keys 6 and electrostatic touch pad 14 of the cellular phone 1 they are not reflected in the control of the BT headphone is considered an inhibiting operation) was performed during the BT-AV connection in the course of BT-AV player reproduction (step S60), and if the inhibiting operation has not been performed, the routine returns to the BY-AV player reproduction (“No”), and when the inhibiting operation is determined to have been performed, the display indicated in step S62 is displayed on the display 5 and the operation is considered ineffective (step S62). Furthermore, if the prescribed interval elapses thereafter, the routine returns to the BT-AV player reproduction.

During the BT-AV player reproduction (step S60), the controller 101 calls out the submenu controlled by pushing the right soft key 66 and determines as to whether or not the sound output destination setting item screen has been called out (step S66). In the case where the sound output destination setting item screen has not been called out, the BT-AV player reproduction is continued (“No” in step S66).

On the other hand, in the case where the controller 101 decides that the sound output destination setting item screen has been called out, the display described instep S33 of FIG. 8 is displayed on the display 5 (<10> FIG. 9).

In the present embodiment of the present invention, the explanation was provided with reference to the cellular phone 1 as an example, but the present invention is not limited to this example and can be also employed in other portable communication terminals (for example, PDA, PHS, and the like). Furthermore, the embodiment was described with reference to BT), but other means based on the close-range wireless communication or cable communication may be also used. For example, in close-range wireless communication, IrDA or wireless LAN may be used. Furthermore, in the case of cable communication, RS-232, USB, IEEE1394, 10Base-T and other LAN interfaces may be used.

According to this embodiment of the present invention, even when an incoming call is generated in the cellular phone 1 during BT connection to a BT-AV device and reproduction of tune information, the ringtone information can flow to the BT-AV device and, therefore, the user can be notified about the generation of the interrupting incoming call.

What is claimed is:

1. A portable communication terminal comprising:
a memory configured to store a plurality of music data and ringtone data;
a sound ringing unit configured to ring a prescribed ringtone based on the ringtone data stored in the memory;
a close-range wireless communication unit configured to transmit a desired first music data from among the plurality of music data stored in the memory to an external device having an external close-range wireless communication function; and
a controlling unit configured to stop the transmission of the first music data and transmit a second music data different from the first music data stored in the memory to the wireless device to the external device if an incoming call interrupts the transmission of the first music data, and then ring a prescribed ringtone based on the ringtone data with the sound ringing unit.

2. The portable communication terminal according to claim 1, wherein the controlling unit transmits the second music data to the external device in a prescribed data amount.

3. The portable communication terminal according to claim 1, wherein the controlling unit transmits the second music data to the external device in data amount sufficient for ringing for a prescribed time period.

4. The portable communication terminal according to claim 1, wherein the controlling unit comprises a transmission controller configured to store information relating to transmission stop of the first music data in the memory if the transmission of the first music data is stopped, and, after talking in the incoming call, transmit the first music data to the external device from a middle stage thereof based on information relating to transmission stop of the first music data stored in the memory.

5. The portable communication terminal according to claim 1, wherein the controlling unit comprises a retransmission controller configured to transmit the first music data from the beginning thereof to the external device, after talking in the incoming call.

6. The portable communication terminal according to claim 1, further comprising an operation unit configured to operate reproduction and stop of the music data stored in the memory, wherein
the controlling unit comprises a controller configured to transmit the first music data from the beginning thereof to the external device via operations of the external device or operations of the operation unit, after the talking in the incoming call.
